(19) United States
(12) Patent Application Publication
(10) Pub. No.: US 2013/0049467 A1
(43) Pub. Date: Feb. 28, 2013

(54) POWER SUPPLY DEVICE

(71) Applicant: CHIEN-TSUNG YEN, Tu-Cheng (TW)

(72) Inventor: CHIEN-TSUNG YEN, Tu-Cheng (TW)

(73) Assignee: HON HAI PRECISION INDUSTRY CO., LTD., Tu-Cheng (TW)

(21) Appl. No.: 13/448,446

(22) Filed: Apr. 17, 2012

(30) Foreign Application Priority Data
Aug. 31, 2011 (TW) 100131398

(51) Int. Cl. H02M 7/04

(52) U.S. Cl. 307/39

(57) ABSTRACT

A power supply device for supplying power to electronic device. The power supply device includes a power supply module and a microchip. The power supply module includes a plurality of Power Supply Units (PSUs) connected to a power source. The microchip is connected to each PSU. The microchip is capable of determining the number of PSUs actually supplying power to the electronic device, and activating a protection circuit only in relation to the PSUs actually supplying power to the electronic device.

### BACKGROUND

1. Technical Field

The present disclosure relates to a power supply device.

2. Description of Related Art

Some electronic device such as servers or storage area networks, consumes excessive amount of power compare to a desktop computer. Thus, a plurality of power supply units (PSUs) must be used to supply power to these types of electronic device. To prevent the device from voltage/current spikes from the PSUs, a protection circuit is provided at the output/input end of each PSU. However, the protection circuits consume energy as soon as the PSUs are connected to the device even though the device is turned off, which waste energy.

Therefore, there is room for improvement within the art.

### BRIEF DESCRIPTION OF THE DRAWINGS

Many aspects of the present disclosure can be better understood with reference to the following drawings. The elements in the drawings are not necessarily drawn to scale, the emphasis instead being placed upon clearly illustrating the principles of the disclosure.

FIG. 1 is a block diagram of an exemplary embodiment of the power supply device.

FIG. 2 is a circuit diagram of one embodiment of the protection circuit and the microchip of the power supply device shown in FIG. 1.

### DETAILED DESCRIPTION

In general, the word “module” as used herein, refers to logic embodied in hardware or firmware, written in a programming language, such as, for example, Java, C, or in assembly. One or more modules may be embedded in firmware, such as in an EPROM. It will be appreciated that a module may comprise connected logic units, such as gates and flip-flops, and may comprise programmable units, such as programmable gate arrays or processors. The modules described herein may be implemented as either software and/or hardware modules and may be stored in any type of computer-readable medium or other computing system storage device.

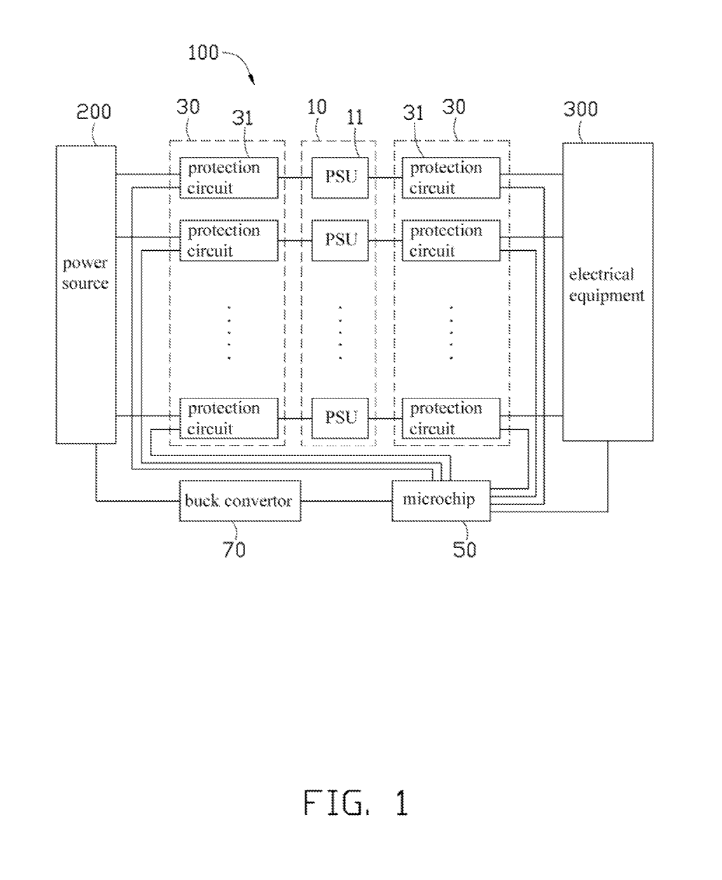

FIG. 1 is a block diagram of a power supply device 100 according to an embodiment. The power supply device 100 connects to a power source 200, to obtain power from the power source 200, and then supplies the power to an electronic device 300. In this embodiment, the electronic device 300 is a server, a storage device(s), a network system, or any other device consuming more power than normal. The power supply device 100 includes a power supply module 10, two protection modules 30, and a microchip 50. The power supply module 10 includes a plurality of a power supply unit (PSU) 11. Each protection module 30 includes a plurality of a protection circuit 31. As such, the input end of each PSU 11 connects to the power source 200 via one protection circuit 31, the output end of each PSU 11 connects to the electronic device 300 also via another protection circuit 31. The microchip 50 connects to each protection circuit 31, and is capable of switching on/switching off each protection circuit 31. The microchip 50 is further capable of switching on a specified number of the protection circuits 31 according to both the actual power being consumed by the electronic device 300 and the maximum power output available from the plurality of

PSUs 11. Thereafter, the power supply device 100 supplies power to the electronic device 300 via the specified number of PSUs 11.

In this exemplary embodiment, the power source 200 is a source of direct current (DC) electrical power, for providing power to the power supply module 10. The electronic device 300 electrically connects to the supply module 10 via a protection module 30, to obtain power with a specified voltage from the supply module 10.

Each PSU 11 can convert voltage from the power supply source 200 to a specified voltage for the electronic device 300.

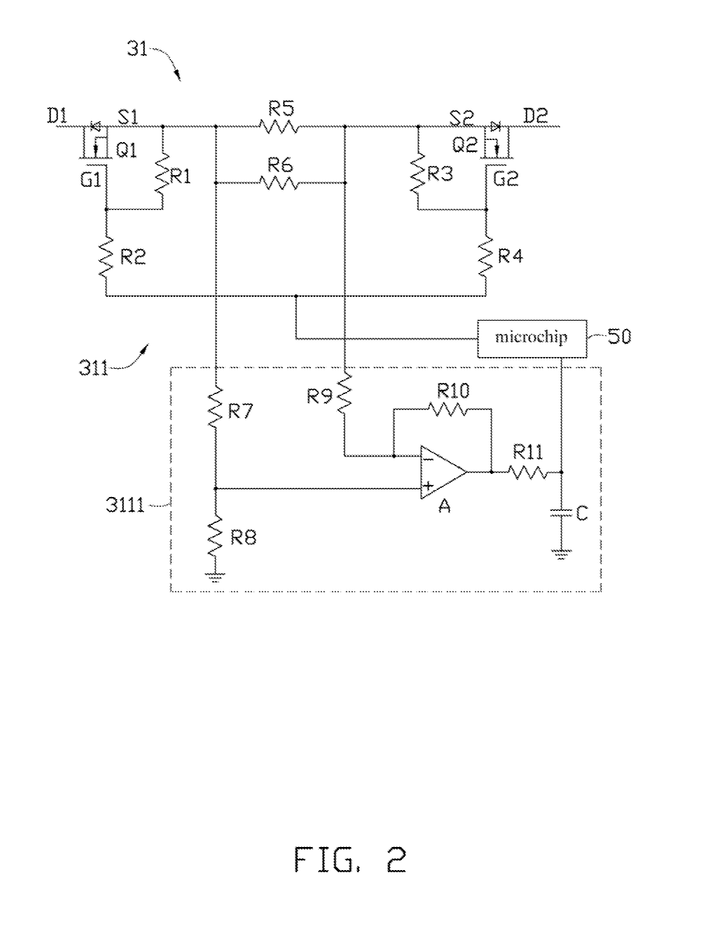

Also referring to FIG. 2, each protection circuit 31 includes a first switch Q1, a second switch Q2, and a sensing circuit 311. The first switch Q1 and the second switch Q2 are both a metal-oxide semiconductor field effect transistor (MOSFET). The first switch Q1 includes a drain D1, a source S1, and a gate G1. The second switch Q1 includes a drain D2, a source S2, and a gate G2.

The drain D1 of the protection circuit 31 at the input end of the PSU 11 electrically connects to the power source 200. The source Si electrically connects to the source S2, and further connects to the microchip 50 via resistors R1, R2. The gate G1 is connected between the resistor R1 and resistor R2. The source S2 of the second switch Q2 also connects to the microchip 50 via the resistors R3, R4. The drain D2 connects to the input end of the PSU 11. The gate G2 connects between the resistor R3 and the resistor R4.

The protection circuit 31 provided at the output end of the PSU 11 is different from the protection circuit 31 provided at the input end of the PSU 11 in that the drain D1 electrically connects to the output end of the PSU 11, and the drain D2 electrically connects to the electronic device 300. When the microchip 50 sends a logic high signal to the gates G1 and G2, the switches Q1 and Q2 are turned on, and power from the power source 200 flows through one protection circuit 31, the PSU 11, and the other protection circuit 31 in that order, to the electronic device 300. When the microchip 50 sends a logic low signal to the gates G1 and G2, the switches Q1 and Q2 are turned off, thus preventing current flowing from the power source 200 to the electronic device 300.

The sensing circuit 311 includes a sensing resistor R5 and an amplifying circuit 3111. The sensing resistor R5 is electrically connected between the source Si and the source S2. The amplifying circuit 3111 connects to the two opposite ends of the sensing resistor R5, for measuring voltage on the sensing resistor R5. The microchip 50 is capable of calculating current on the protection circuit 31 (i.e., current on the sensing resistor R5) according to the measured voltage and resistance of the sensing resistor R5. In this exemplary embodiment, the sensing circuit 311 can further include a resistor R6, which is parallel to the resistor R5, and equals the resistor R5 in value.

The amplifying circuit 3111 includes resistors R7, R8, R9, R10, R11, an operational amplifier A, and a capacitance C. The resistors R7, R9 are electrically connected to a different opposite end of the resistor R5. The resistor R8 connects between the resistor R7 and ground. The resistor R10 connects between the resistor R9 and the output end of the amplifier A. The positive input of the operational amplifier A connects to a node between the resistors R7 and R8, and the negative input of the amplifier A connects to a node between the resistors R9 and R10. The resistor R11 is connected between the output of the amplifier A and one terminal of capacitance C, this terminal of capacitor C is also connected to the microchip 50. The other terminal of capacitor C is grounded. In this exemplary embodiment, the resistor R7 equals the resistor R9 in value, the resistor R8 equals the resistor R10 in value.

As soon as the microchip 50 receives a start-up signal from a turn-on button (not shown) on the electronic device 300, the microchip 50 controls the PSUs 11 to supply power to the electronic device 300. In this embodiment, each PSU 11 has the same maximum power output. The microchip 50 calculates the number of the PSUs 11 supplying power to the electronic device 300 according to the actual power being consumed by the electronic device 300 and the maximum power output from the PSUs 11. Then the microchip 50 switches on the protection circuits 31 which are positioned on the opposite ends of the PSUs 11 which are actually supplying power, and switches off the other protection circuits 31. In this exemplary embodiment, the microchip 50 is capable of measuring actual voltage of the PSU 11, and calculating the actual power of each PSU 11 according to the measured voltage and current from the PSU 11 to the electronic device 300. The sum of the actual amounts of power being supplied by the PSUs 11 is the actual or deemed power consumption of the electronic device 300. Thus, the microchip 50 determines the number of PSUs 11 which supply power according to both the actual power of the electronic device 300 and the maximum power of each PSU 11. In addition, the maximum efficiency of the PSUs 11 is when the PSU 11 is supplying fifty percent of its maximum possible output. Thus, the number of the PSUs 11 supplying power can be determined according to twice the amount of the actual power being consumed by the electronic device 300.

In this exemplary embodiment, the microchip 50 is capable of predetermining a maximum current of both the input end and the output end of the PSU 11. Thereafter, the microchip 50 switches off the protection circuit 31 relating to a PSU 11 as soon as actual current of the PSU 11 is determined as exceeding the predetermined current, for preventing any overcurrent to the PSU 11 or the electronic device 300.

The power supply device 100 further includes a buck converter 70 electrically connected to both the source 200 and the microchip 50, for supplying power to the microchip 50 before power is supplied to the electronic device 300. Thus, the microchip 50 can receive the start-up signal from the pressed turn-on bottom of the electronic device 300 before the electronic device 300 is turned on.

When the turn-on button of the electronic device 300 is pressed, the microchip 50 receives the start-up signal, and switches on each protection circuit 31, to activate each PSU 11 to supply power to the electronic device 300. The microchip 50 determines the number of PSUs 11 engaged in actually supplying power according to twice the amount of the actual power being consumed by the electronic device 300 and the maximum power output of each of the PSUs 11. Then the microchip 50 switches on the protection circuit 31 connected to the determined quantity of the PSUs 11, and switches off the other protection circuit 31. Thus, only a proportion of the PSUs 11 supply power to the electronic device 300, and each PSU 11 is at half-load, which results in maximum efficiency and the smallest loss of power.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A power supply device, comprising:
a power supply module, comprising a plurality of power supply units (PSUs), each PSU connected to a power source, for converting voltage from the power source to a specified voltage for an electronic device; and
a microchip connecting to each PSU, for determining the number of PSU supplying power to the electronic device according to both the actual power being consumed by the electronic device and the maximum power output from the PSUs, and further determining the number of PSUs to supply power to the electronic device.

2. The power supply device of claim 1, further comprising two protection modules, wherein each protection module comprises a plurality of protection circuits, the input end of each PSU is connected to the power source via one protection circuit, the output end of each PSU is connected to the electronic device via another protection circuit, the microchip is capable of switching on the protection circuits connected to the PSU, for activating the switched PSU to supply power to the electronic device; the microchip is further capable of switching off the protection circuits connected to the PSU, for stopping the switched PSU supplying power to the electronic device.

3. The power supply device of claim 1, wherein each protection circuit comprises a first switch and a second switch connected to the microchip, the first switch of the protection circuit provided at the input end of the PSU is connected to the power source, the second switch is connected to the input end of the PUS; the first switch of the protection circuit provided at the output end of the PSU is connected to the output end of the PSU, the second switch provided at the output end of the PSU is connected to the electronic device.

4. The power supply device of claim 3, wherein each switch comprises a drain, a source, and a gate, when the protection circuit is electrically provided at the input end of the PSU, the drain of the first switch is connected to the power source, the source of the first switch is connected to the source of the second switch, and is further connected to the microchip via two resistors, the gate of the first switch is connected between the two resistors; the drain of the second switch is connected to the input end of the PSU, the source of the second switch is further connected to the microchip via another two resistors, the gate of the second switch is connected between the another two resistors.

5. The power supply device of claim 3, wherein when the protection circuit is electrically provided at the output end of the PSU, the drain of the first switch is connected to the output end of the PSU, the source of the first switch is connected to the source of the second switch and is further connected to the microchip via two resistors, the gate of the second switch is connected between the two resistors; the drain of the second switch is connected to the electronic device, the source of the second switch is connected to the microchip via another two resistors, the gate of the second switch is connected between the another two resistors.

6. The power supply device of claim 3, wherein the protection circuit further comprises a sensing circuit connected to the output end of the PSU, for sensing current from the PSU to the electronic device, the microchip is capable of measuring the actual voltage of the PSU, and determining the actual power of each PSU according to the measured voltage and the current, further determining the actual power of the electronic device according to the sum of the actual power from all the PSU.

7. The power supply device of claim 6, wherein the sensing circuit further connects to the input end of the PSU, for sensing current to each PSU, the microchip is capable of switching off the protection circuits positioned beside the PSU when determining current to the PSU or current from the PSU exceeding a predetermined current.

8. The power supply device of claim 6, further comprising a buck converter connected to the microchip and the power source, for supplying power to the microchip, and enabling the microchip receiving a start-up signal as soon as the electronic device is started, the microchip further capable of switching on all the protection circuits to enabling all the PSUs to supplying power to the electronic device when the electronic device is started, then the microchip controls a number of PSUs to supplying power.

9. The power supply device of claim 1, wherein the microchip is capable of determining the number of supplying PSU according to twice the actual power of the electronic device, to enable the supplying PSU to work in a half maximum power and a maximum efficiency.
